(19) United States
(12) Patent Application Publication
(10) Pub. No.: US 2003/0079023 A1
(43) Pub. Date: Apr. 24, 2003

(54) Wireless communication protocol

(76) Inventors: Thorarinn Stefansson, Reykjavik (IS); Einar Bergsson, Reykjavik (IS); Fridrik Thor Reynisson, Reykjavik (IS); Thorsteinn Helgi Steinarsson, Kopavogur (IS); Finnur Sigurdsson, Reykjavik (IS)

Correspondence Address: KAPLAN & GILMAN , L.L.P., 900NROUTE 9 NORTH, WOODBRIDGE, NJ, 07095, US

(21) Appl. No.: 10/001,946

(22) Filed: Oct. 19, 2001

(51) Int. Cl. G06F 15/16

(52) U.S. Cl. 709/227; 709/250

(57) ABSTRACT

The invention disclosed provides a system that includes simulation software to enable a local server to appear to a client computer as a communication service provider and a server remote from the client computer to appear to the communication service provider as the client computer. The invention further provides a method implemented through disclosed software by which multiple packets from a single sending application are accumulated so that a single connection can be established for transmission. A single connection is established for transmitting the message. A further aspect of the invention determines the priority of the message and designates higher priority control messages to be transmitted on a reserved high priority channel.

### FIELD OF THE INVENTION

The present invention relates to the field of communications, and more particularly to the efficient handling of messages in a wireless environment.

### BACKGROUND OF THE INVENTION

Wireless communication provides a great convenience for its users. Wireless communication devices are completely portable, so that the user can initiate calls from anywhere and can be contacted anywhere he or she is located. Mainly because of this great convenience, wireless phones and palm computer devices have become extremely popular.

Along with the increase in the popularity of wireless communication devices, new hardware and software are proliferating. All of this means an increasing demand for transmission bandwidth, which, by definition, is finite. In order to utilize the available bandwidth efficiently, packetization has become the chosen mode of message transmission. Further, information within packets is being compressed by mathematical manipulation according to various algorithms before their transmission to a receiving device. The compressed information is then decompressed upon receipt.

In present systems, when a message is initiated from a sender to a receiver, a connection route is established that is based on information encoded in the message packet header. Since a related email server is typically located near to an ISP, and far from the sender, a certain amount of time is required for transmission to and from the server for the process of handshaking and establishing a connection. Wireless communications tend to require an especially long time, thus bandwidth, for this preliminary processing.

When a web page is being opened, the opening application, for example Windows Explorer, will typically create plural connections. Each connection includes a separate TCP/IP overhead block, which occupies added bandwidth. For a wireless device receiving this transmission, the plurality of overhead blocks represents a loss in efficiency and therefore degradation in performance. It is thus recognized that if the number of required connections for a message could be reduced, the message would comprise a greater proportion of the transmitted data, increasing efficiency and preserving precious bandwidth. This efficiency factor applies similarly to most messages with packet headers because the header occupies a proportionately large segment of the total packet transmission requirement, and to the extent that packets can be combined or eliminated, the individual headers could be minimized.

Part of the data transmission that goes between the source and the destination is related to protocol (message or packet transmission control, handshake, etc). It is very common that Internet communication protocols (or clients—server protocols in general) require large amounts of bandwidth for wireless transfer. Thus it is recognized that by wrapping protocol portions of the transmission together the utilization of bandwidth can be enhanced. The utilization of the wireless link can be improved by combining controls, reducing handshake, enabling intelligent compression of control structures, etc.

An additional increase in efficiency can be attained by permitting certain types of protocol data access to bandwidth ahead of others. Thus by applying intelligent protocol conversion or wrappings over the wireless link and by designating higher priority to all protocol data possible, this data is transmitted expeditiously to permit a more efficient use of the system capabilities. Messages with no more than a standard need for rapid transmission (normal priority) or sequential data can thus be sent at normal speed, but non-sequential protocol data can be given higher priority to bypass any other data pending for transmission.

Therefore, it is an object of the present invention to reduce the number of connections needed for a wireless transmission.

It is a further object of the present invention to ensure the rapid delivery of non-sequential protocol data.

These and other objects will become more apparent from the description of the invention to follow.

### SUMMARY OF THE INVENTION

The present invention is embodied in a software program adapted to improve transmission efficiency and optimize the use of available bandwidth. A first aspect of the invention is to combine the data stream from multiple sources into one data stream before it is transmitted to a receiving client device. A second aspect of the invention is to apply intelligence about native protocol to convert it into a more optimized wireless protocol. A third aspect of the invention divides the data communication of the single data stream so as to expedite the transmission of non-sequential or higher priority data through a specified high priority channel ahead of normal priority communications. The segregation of the different types of packet is accomplished through a series of queries directed to identifying factors in the packet headers.

### BRIEF DESCRIPTION OF THE DRAWINGS

FIG. 1 is a schematic representation of a communication system utilizing the reciprocal simulative device feature of the invention.

FIG. 2 is a flowchart for combining data from multiple sending applications and segregating messages of high priority control information for efficient transmission.

### DETAILED DESCRIPTION OF THE INVENTION

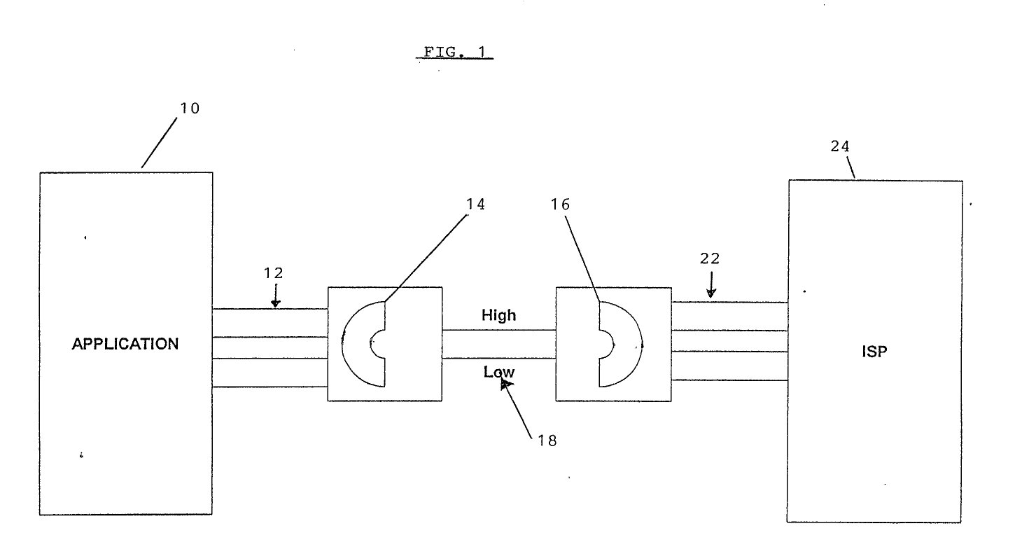

A first aspect of the invention is illustrated as a diagrammatic apparatus in FIG. 1. The apparatus of the invention involves an improvement on known client server systems, for example, email handling systems, by the imposition of a novel feature as follows. The system is for the transmission of communication between an application client 10 and a service provider hosting the server part, for example ISP 24, which communication will ultimately be sent to an intended recipient application (not shown). The communication is sent from application 10 over any one of a group of connecting links 12 to a local server 14. Connecting links 12 may be hardwired or wireless, as is the case with each of the connecting elements in the system. Local server 14 is connected to a remote server 16 by at least two communication links 18, capable of transmitting data in wireless and optical form. Remote server 16 is connected to ISP 24 through a plurality of connecting links 22. Although remote server 16 is deemed remote with respect to application 10, it is substantially local with respect to ISP 24.

As discussed above, an object of the invention is to reduce the quantity of information that must be processed and transmitted over links 18, thereby utilizing the available bandwidth more efficiently. An initial portion of information involves establishing a connection through which actual communication will flow. The conventional process of establishing such a connection is to send preliminary messages containing, e.g. message encoding data, message existence, etc. Sending these preliminary messages uses bandwidth. The invention recognizes that sending these preliminary messages over long distances occupies bandwidth for longer times. For these reasons, local server 14 is programmed to simulate a communication service provider, for example an ISP, to application 10, allowing local server 14 to establish a needed communication link 18, and allowing local server 14 to transmit substantive communication content more effectively. Remote server 16 is programmed to simulate a client to ISP 24, allowing remote server 16 to utilize communication link 18 more efficiently.

By enabling a simulated client to be presented to ISP 24 and a simulated server to be presented to application 10, the invention enables the establishment of communications on long distance links 18. The reciprocal simulated devices are physically close to the respective originating source, leaving the longer transmission distance to be broached after the initial connection has been established. This means that bandwidth over the main links is preserved for substantive message content.

Local server 14 and remote server 16 each can understand the protocol in the data exchange between application 10 and ISP 24. This enables an optimization of the protocol by combining, delaying, skipping or inserting control commands into the data stream in order to optimize it across link 18.

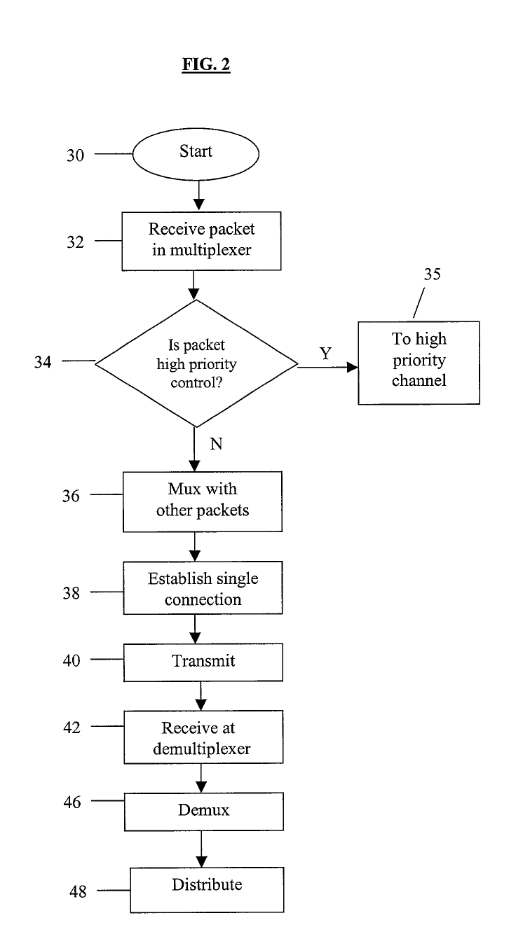

Referring now to FIG. 2, a second aspect of the invention is provided to optimize utilization of bandwidth by combining packets from multiple applications for transmission under a single connection header, with debundling and distribution to recipient applications being accomplished at the receiving end. The process is started at step 30. Individual packets of message data are received from one or more applications by a multiplexer apparatus at step 32. A determination is made at step 34 as to whether the packet contains a high priority control instruction. An example of high priority control instruction is “Get New Transmissions.” If the packet contains a high priority control, it is sent to a high priority channel at step 35 for transmission. If it is not a high priority control, it is either a data transmission or a low priority control, e.g. “End Of Messages.” The receiving multiplexer multiplexes the packets together at step 36 and then establishes a single connection for transmission of the plurality of multiplexed packets at step 38. The system uses the single established connection to transmit the multiplexed packets at step 40 over the Internet or other communication network. A receiving demultiplexer receives the multiplexed packets at step 42. The receiving demultiplexer then demultiplexes the packets at step 46 and the packets are distributed to the intended recipient client applications at step 48. Subsequently, the receiving applications combine packets from various sources and assemble associated packets to form a complete message.

As described herein, the invention provides a process for improving the allocation and utilization of available bandwidth based upon reciprocal split-proxy features, a possible reduction in the number of connections and related TCP/IP header data needed, and also on a determination of priority so as to send higher priority packets through a special reserved channel.

While the present invention is described with respect to specific embodiments thereof, it is recognized that various modifications and variations may be made without departing from the scope and spirit of the invention, which is more clearly and precisely defined by reference to the claims appended hereto.

What is claimed is:

1. A system for transmitting data from a client computer to a remote computer, the system comprising:
(a) a communication service provider simulative server in communication with the client computer; and
(b) a client computer simulative server in communication with the remote computer and with the communication service provider simulative server.

2. The system for transmitting data as described in claim 1, wherein the remote computer comprises a communication service provider.

3. The system for transmitting data as described in claim 2, wherein the communication service provider comprises an Internet service provider.

4. The system for transmitting data as described in claim 1, wherein the client computer and the remote computer are in communication with one another so as to transmit data via optical signals.

5. The system for transmitting data as described in claim 1, wherein the client computer and the remote computer are in communication with one another via wireless link.

6. A system for transmitting data from a client computer to a remote computer, the system comprising:
(a) a local server in communication with the client computer and programmed to appear to the client computer as a communication service provider;
(b) a remote server in communication with the local server;
(c) a communication service provider in communication with the remote server; and
(d) wherein the remote server is programmed to appear to the communication service provider as a client computer.

7. A system for implementing communications between a client computer and one or more remote computers, the system comprising:
(a) one or more software applications operating on the client computer;
(b) a remote computer simulator for presenting to the one or more applications a communications interface that appears as a remote computer;
(c) a client simulator for presenting to the remote computer a communications interface that appears as the client;
(d) means coupled to the remote computer simulator for multiplexing plural communication connections from the client into a single communications session between the client simulator and the remote computer simulator, the multiplexing means combining data of different priorities, all data above a specific priority being combined into a first communication channel.

8. A communication method comprising the steps of:
(a) receiving a plurality of data packets;
(b) combining the plurality of data packets together;
(c) establishing a single connection for transmitting the combined plurality of data packets; and
(d) transmitting the combined plurality of data packets.

9. The communication method as described in claim 8, wherein the step of receiving is performed by a multiplexer and the step of combining comprises multiplexing.

10. The communication method as described in claim 8, further comprising:
(a) determining whether the message is a high priority control message;
(b) if the message is determined to be a high priority control message, transmitting the message on a high priority channel; and
(c) if the message is determined not to be a high priority control message, transmitting the message on a normal priority channel.

11. The communication method as described in claim 8, further comprising:
(a) receiving the combined plurality of packets;
(b) separating the combined plurality of packets; and
(c) distributing the separated plurality of packets.

12. The communication method as described in claim 11, wherein the step of receiving is performed by a demultiplexer and the step of combining comprises demultiplexing.

13. A communication protocol comprising the steps of:
(a) receiving a packet containing data;
(b) determining whether the packet is high priority control;
(c) if the packet is not of high priority control, combining the packet with other packets for transmission in a normal priority channel.

14. The communication protocol as described in claim 13, wherein if the packet is of high priority control, designating the packet for transmission in a high priority channel.
